(19) United States
(12) Patent Application Publication
(10) Pub. No.: US 2019/0373661 A1
(43) Pub. Date: Dec. 5, 2019

(54) BASE STATION AND COMMUNICATION DEVICE SUPPORTING LOCALIZED WIRELESS COMMUNICATION SERVICE

(71) Applicant: Huawei Technologies Co., Ltd., Shenzhen (CN)

(72) Inventors: Apostolos KOUSARIDAS, Munich (DE); Alexandros KALOXYLOS, Munich (DE); Chan ZHOU, Munich (DE)

(21) Appl. No.: 16/528,095

(22) Filed: Jul. 31, 2019

Related U.S. Application Data
(63) Continuation of application No. PCT/EP2017/051991, filed on Jan. 31, 2017.

(51) Int. Cl. H04W 76/15; H04W 4/70; H04L 29/08

(52) U.S. Cl. CPC H04W 76/15; H04W 88/08; H04L 67/146; H04W 4/70

(57) ABSTRACT

The disclosure relates to a base station, BS, for enabling radio bearers' establishment and radio path formation to support end-to-end transmission of localized data among a group of communication devices, in particular machine-type communication, MTC, devices, the BS comprising: a radio controller configured: to receive a session request message from a communication device of the group of communication devices, wherein the session request message comprises information about a specific service; to establish a plurality of radio bearers among the group of communication devices and to form a plurality of radio paths over the plurality of radio bearers according to the information about the specific service to support end-to-end transmission of localized data between the communication devices of the group of communication devices.

### CROSS REFERENCE TO RELATED APPLICATIONS

This application is continuation of International Application No. PCT/EP2017/051991, filed on Jan. 31, 2017, the disclosure of which is hereby incorporated by reference in its entirety.

### TECHNICAL FIELD

The present disclosure relates to a base station (BS) and a communication device such as a machine type communication (MTC) device supporting localized wireless communication service. In particular, the present disclosure relates to a method and apparatus for fast bearer establishment and data paths formation for localized wireless communications.

### BACKGROUND

The growth of Machine Type Communications (MTC) poses new QoS (quality of service) requirements to the communication systems. Different types of MTC devices such as vehicles, robots, industrial machines and drones will collaborate having challenging performance requirements to the communication systems (e.g., lower latency, higher reliability). The communication among self-driving vehicles is a typical example, where less than 10 ms end-to-end (e2e) latency and reliability higher than 99.99% are required to support a wide range of Vehicle-to-everything (V2X) use cases (e.g., cooperative collision avoidance of self-driving vehicles).

Existing communication systems suffer from the following problems: slow establishment of radio bearers for the support of localized MTC services that have low latency and high reliability requirements; and the formation of efficient local end-to-end radio data paths (in the same cell or among neighboring cells) that enable the fast and reliable transmission of localized data traffic among the involved MTC devices, supporting different communication modes (unicast, multicast, broadcast) without the need to interact with other entities such as MBMS (multimedia multicast/broadcast service).

Current proposals and existing standardized procedures for establishing and managing radio bearers have been designed taking into account mainly the requirements of traditional services e.g., voice, VoIP, video and web data services. Existing technical solutions are not suitable to support the needs for very fast establishment of end-to-end radio bearers and the fast transmission of localized data traffic in an efficient way. In addition, none of the existing solutions have focused on the support of services that the data communication among the involved devices is mainly localized.

### SUMMARY

It is the object of the embodiments of the invention to provide a concept for a communication system that is suitable for different types of localized services, in particular MTC services such as vehicular communications that set strict performance requirements for both the control plane (bearers establishment) and the data plane (data traffic transmission), and for the cooperation among robots and the synchronization of drones.

This object is achieved by the features of the independent claims. Further implementation forms are apparent from the dependent claims, the description and the figures.

A basic concept of the embodiments of the invention is to extend existing bearer establishment messages as well as to modify time consuming functions that are involved in the connection (or bearer) establishment. As shown in this disclosure, the bearer establishment (c-plane) delay has been initially minimized by avoiding the involvement of the Core Network or any MBMS entity. According to the disclosure, both cases are supported, that the devices (e.g., vehicles, robots) do not have an active connection to the RAN and also that the devices have always access to signaling resources either immediately or with very low delay (e.g., in LTE RRC assignment of SRB 1, without the need to repeat context retrieval or security activation process by other involved entities). All functions for establishing and configuring new bearers that are required for the services, are located at the RAN (e.g., BS) together with the necessary service or network information (e.g., group of involved devices, position of the devices etc.). This information is available at the Base Station (BS) either by periodic transmissions of the involved devices or by the dedicated messages that are described in the following disclosure for the establishment of a new bearer, contributing further to reduction of the c-plane delay.

The disclosure presents a new MTC-device configured to transmit a Session Request message to the Base Station including service and radio information, that are used by the Base Station in order to check the availability of resources, to establish the radio bearers, to update the Radio Bearers' Mapping Table and form the local end-to-end radio data paths for the MTC devices involved in a specific MTC service. The disclosure further presents a new Base station configured to transmit a Notification for the Session Request message to inform the MTC devices in the same geographical area (e.g., cell area) about the already transmitted Session Requests and thus avoid the transmission of multiple Session Request messages for the same service/event by different involved MTC devices. The Base Station sends to each involved MTC device the Radio Paths Configuration message, which includes the configuration of the Radio Bearers and the end to end radio paths, information for forwarding of user data over the radio paths and the allocated user plane Radio Resources for the fast user plane transmission. The Involved MTC devices confirm the successful completion of the establishment of the new radio bearers and radio paths with the Radio Paths Configuration Complete message that is sent to the Base Station.

The devices, systems and methods according to the disclosure provide a solution to the above described problem by accelerating establishment of radio bearers and improving efficiency of forming local end-to-end radio data paths.

The devices described herein may be implemented in wireless communication networks, in particular communication networks based on mobile communication standards such as LTE, in particular LTE-A and/or OFDM and 5G. The devices described herein may further be implemented in base stations (or NodeBs or eNodeBs or radio cells) and in communication devices such as mobile devices (or mobile stations or User Equipments (UEs)), for example in the scenario of machine-to-machine (M2M) communication enabling networked devices to exchange information and perform actions without the manual assistance of humans or in the scenarios of machine-type communication (MTC) or device-to-device (D2D) or vehicle-to-anything (V2X) communication where one mobile device communicates with another mobile device (either by using a communication path traversing the base station or by a communication path non-traversing the base station). The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

D2D communications in cellular networks is defined as direct communication between two mobile devices or mobile users without traversing the Base Station (BS) or eNodeB or the core network. D2D communications is generally non-transparent to the cellular network and can occur on the cellular spectrum (i.e., inband) or unlicensed spectrum (i.e., outband). D2D communications can highly increase spectral efficiency, improve throughput, energy efficiency, delay, and fairness of the network. The techniques described herein may be implemented in communication devices and base stations (or eNodeBs or radio cells) communicating under MTC, M2M and D2D scenarios. Vehicle-to-everything (V2X) communication is the passing of information from a vehicle to any entity that may affect the vehicle, and vice versa.

The devices described herein may be configured to transmit and/or receive radio signals. Radio signals may be or may include radio frequency signals radiated by a radio transmitting device (or radio transmitter or sender) with a radio frequency lying in a range of about 3 kHz to 300 GHz. The frequency range may correspond to frequencies of alternating current electrical signals used to produce and detect radio waves.

The devices described herein may be designed in accordance to mobile communication standards such as e.g. the Long Term Evolution (LTE) standard or the advanced version LTE-A thereof. LTE (Long Term Evolution), marketed as 4G and 5G LTE and beyond, is a standard for wireless communication of high-speed data for mobile phones and data terminals.

The devices described herein may be applied in OFDM systems. OFDM is a scheme for encoding digital data on multiple carrier frequencies. A large number of closely spaced orthogonal sub-carrier signals may be used to carry data. Due to the orthogonality of the sub-carriers crosstalk between sub-carriers may be suppressed.

In order to describe the embodiments of the invention in detail, the following terms, abbreviations and notations will be used:
MTC: Machine-Type Communication (device)
M2M: Machine-to-Machine (communication)
D2D: Device-to-device
V2X: Vehicle-to-everything
IoT: Internet of Things
e2e: end-to-end
MBMS: multimedia multicast/broadcast service
OFDM: Orthogonal Frequency Division Multiplex
DL: Downlink
UL: Uplink
BS: Base Station, eNodeB, eNB
UE: User Equipment, e.g. a mobile device or a machine type communication device
4G: 4^{th} generation according to 3GPP standardization
5G: 5^{th} generation according to 3GPP standardization
LTE: Long Term Evolution
RF: Radio Frequency
TX: Transmit
RX: Receive

According to a first aspect, the embodiments of the invention relate to a base station (BS) for enabling radio bearers' establishment and radio path formation to support end-to-end transmission of localized data among a group of communication devices, in particular machine-type communication (MTC) devices, the BS comprising: a radio controller configured: to receive a session request message from a communication device of the group of communication devices, wherein the session request message comprises information about a specific service; and to establish a plurality of radio bearers among the group of communication devices and to form a plurality of radio paths over the plurality of radio bearers according to the information about the specific service to support end-to-end transmission of localized data between the communication devices of the group of communication devices.

Such a base station is suitable to support the needs for very fast establishment of end-to-end radio bearers and the fast transmission of localized data traffic in an efficient way. In particular the BS supports localized services for the data communication among the involved devices. The specific service may be a service provided for a group of communication devices that are localized within a specific geographic area, e.g. vehicles within a specific distance with respect to each other. For example the service may be a service aiding collision detection and/or avoidance. The service may for example include a localized communication between the communication devices localized within the specific geographic area. The service may for example include adjusting a velocity of the vehicles with respect to each other.

In a first possible implementation form of the BS according to the first aspect, the radio controller is configured to initiate a session for providing the specific service and to generate a session identifier indicating the initiated session and/or the specific service.

This provides the advantage that the offered service can be treated within a session having a session ID which uniquely identifies the required service. Different services can be specified within the session, e.g. vehicular services such as lane merging, cooperative collision avoidance, etc.

In a second possible implementation form of the BS according to the first aspect as such or according to the first implementation form of the first aspect, the session request message comprises information elements providing the information about the specific service, the information elements comprising at least one of: a type of the specific service, a location of the communication device transmitting the session request message, information about communication devices involved in the specific service, application layer information, e.g. payload of transmitted message, channel quality information of the communication device transmitting the session request message, in particular a reference signal receive power (RSRP) and/or a channel quality identifier (CQI).

This provides the advantage of an important reduction (more than 50%) of the control plane delay to establish the required radio bearers for all the involved devices together with the respective reduction of the signaling overhead. This is because of the reduction of the interactions with the core network entities and the provision of service-layer information in the Session Request message from the initiating device that facilitate the faster establishment of radio bearers for all involved devices. Within this control plane latency all the involved devices have been informed about the new service and all the required radio bearers have been established together with the radio paths. In addition, initial user plane resources have been provided within this control plane phase, something that is very useful for emergency services.

In a third possible implementation form of the BS according to the first aspect as such or according to any of the preceding implementation forms of the first aspect, the radio controller is configured to transmit a notification message to the communication devices of the group of communication devices, wherein the notification message comprises information about the radio paths formation initiated by the session request message.

Transmitting the notification message provides the advantage that transmission of multiple requests for the same service event by the other involved devices can be omitted, thereby reducing the signaling overhead. In one variant of the third implementation form, the notification message is a broadcast message sent in the context of the cell. This provides the advantage that only one message with the required information has to be sent.

In a fourth possible implementation form of the BS according to the third implementation form of the first aspect, the information about the radio paths formation comprises at least one of: an identifier of the communication device initiating the session request message, a location of the communication device initiating the session request message, a type of the specific service, identifiers of the communication devices involved in the specific service, a session identifier of the specific service.

This provides the advantage that the information about the radio paths formation can be agreed between the BS and the respective communication device. The communication device can confirm the successful completion of the establishment of the radio paths according to the requested features of the service.

In a fifth possible implementation form of the BS according to the first aspect as such or according to any of the preceding implementation forms of the first aspect, the BS comprises: a radio bearers mapping table, configured to maintain information about the plurality of established radio bearers, wherein the radio controller is configured to update and configure the radio bearers mapping table based on the established radio bearers.

This provides the advantage that by local end-to-end radio data paths and the introduction of the Radio Bearers Mapping Table at the BS, faster user plane (u-plane) transmission of data traffic (e.g., V2X traffic) can be achieved due to the localized communication, and the absence of the need of the IP protocol procedures and any interaction with the MBMS entities. Moreover, the initial allocation of the u-plane resources in the context of the control plane signaling for bearers' establishment, reduces further the communication delay and the signaling overhead because of the scheduling requests and grants that are not exchanged between the involved devices and the BS for the initial steps of the MTC service, i.e., reduced signaling and delay.

In a sixth possible implementation form of the BS according to the fifth implementation form of the first aspect, the radio controller is configured to generate a unique identifier in the radio bearers mapping table for a specific session initiated by a session request message and to associate all radio bearers established to support a specific transmission mode with the unique identifier, in particular a unicast transmission mode or a multicast transmission mode.

This provides the advantage that by the unique identifier all data and parameters for the specific session can be identified and stored in the radio bearers mapping table. Further devices that want to connect to the service can use the same data and parameters stored in the radio bearers mapping table. This provides an improved service provision.

In a seventh possible implementation form of the BS according to any of the fifth or the sixth implementation form of the first aspect, the radio controller is configured to transmit a radio paths configuration message to the communication devices of the group of communication devices, wherein the radio paths configuration message comprises information about a configuration of the formed plurality of radio paths.

This provides the advantage that by using the radio paths configuration message the involved devices can efficiently establish and configure the required service according to their needs. The BS can schedule, together with the e2e radio bearers' establishment, also user plane resources to enable the quick u-plane (local) transmission among the involved devices in the cell avoiding additional scheduling request delay.

In an eighth possible implementation form of the BS according to the seventh implementation form of the first aspect, the information about the configuration of the formed plurality of radio paths comprises at least one of: a session identifier that uniquely identifies the specific service and session, configuration information for the established plurality of radio bearers, information for configuration of radio interface layers, information and identifiers from the radio bearers mapping table, control plane resources for transmission of a radio path configuration complete message, allocated user plane resources for initial data plane transmission.

This provides the advantage that initial user plane resources can be provided within the control plane phase, something that is very useful for emergency services.

In a ninth possible implementation form of the BS according to the first aspect as such or according to any of the preceding implementation forms of the first aspect, the radio controller is configured to receive a radio path configuration complete message from each communication device of the group of communication devices, wherein the radio path configuration complete message indicates a successful completion of an establishment of radio bearers and formation of radio paths associated with the respective communication device.

This provides the advantage that the BS knows if the radio bearers are correctly established and can proceed with other tasks.

In a tenth possible implementation form of the BS according to the ninth implementation form of the first aspect, the radio path configuration complete message comprises at least one of: a session identifier that identifies the specific service and session, an identifier of the communication device transmitting the radio path configuration complete message.

This provides the advantage that the BS knows which service is established for which communication device. Other communication devices can then be flexible added.

In an eleventh possible implementation form of the BS according to the first aspect as such or according to any of the preceding implementation forms of the first aspect, the radio controller is configured to receive a second session request message from a second communication device that requires participating in the specific service; and the radio controller is configured to transmit a session merge request message to the second communication device allowing the second communication device participating to an initiated session for providing the specific service.

This provides the advantage that the session merge request message allows the second communication device participating to an initiated session for providing the specific service. That means no other session for providing the specific service to the second communication device has to be initiated thereby saving resources.

In a twelfth possible implementation form of the BS according to the first aspect as such or according to any of the preceding implementation forms of the first aspect, the radio controller is configured to transmit an inter node session request message to a neighboring base station when the communication device is attached to the neighboring base station, wherein the inter node session request message comprises the information about the specific service from the communication device; the radio controller is configured to receive an inter node session response message from the neighboring base station in response to the inter node session request message; and the radio controller is configured to transmit an inter node session confirmation message to the neighboring base station in response to receiving the inter node session response message.

This provides the advantage that the established session can be flexibly enhanced to neighboring communication devices and/or neighboring base stations, thereby enlarging the geographic area in which the service is offered or supporting a handover scenario where the communication device moves from a first radio cell to a second radio cell.

In a thirteenth possible implementation form of the BS according to the first aspect as such or according to any of the preceding implementation forms of the first aspect, the session request message comprises a GeoNetworking Address, wherein the GeoNetworking Address indicates a geographical service area in which the specific service is provided by the BS.

The GeoNetworking Address may be used as an alternative approach to describe the involved communication devices, e.g. MTC devices that participate in a specific service and consequently establish the appropriate radio paths. The MTC Devices can be addressed using their geographical location (i.e. their GeoNetworking Address) instead of the IDs of the devices. By using the GeoNetworking Address a more simple method for computing the distance between the communication devices can be applied, e.g. by using a simple subtraction of their geographic coordinates.

In a fourteenth possible implementation form of the BS according to the first aspect as such or according to any of the preceding implementation forms of the first aspect, the radio controller is configured to interact with a machine-type communication (MTC) server before establishing the plurality of radio bearers, in particular by: transmitting a session configuration request message to the MTC server and receiving a session configuration message from the MTC server in response to the session configuration request message.

According to a second aspect, the embodiments of the invention relate to a communication device, in particular a machine-type communication (MTC) device, the communication device comprising: a radio controller configured: to transmit a session request message to a base station, in particular the BS according to the first aspect as such or according to any of the implementation forms of the first aspect, wherein the session request message comprises information about a specific service; to receive a radio paths configuration message from the BS, wherein the radio paths configuration message comprises information about a configuration of a radio path; and to form and configure the radio path according to the information comprised in the radio paths configuration message.

Such a communication device is suitable to support the needs for very fast establishment of end-to-end radio bearers and the fast transmission of localized data traffic in an efficient way. In particular the communication device supports localized services for the data communication among the involved devices. The specific service may be a service provided for a group of communication devices that are localized within a specific geographic area, e.g. vehicles within a specific distance with respect to each other. For example the service may be a service aiding collision detection and/or avoidance. The service may for example include a localized communication between the communication devices localized within the specific geographic area. The service may for example include adjusting a velocity of the vehicles with respect to each other.

In a first possible implementation form of the communication device according to the second aspect, the session request message comprises information elements providing the information about the specific service, the information elements comprising at least one of: a type of the specific service, a location of the communication device, information about other communication devices involved in the specific service, application layer information, channel quality information of the communication device, in particular a reference signal receive power (RSRP) and/or a channel quality identifier (CQI).

This provides the advantage of an important reduction (more than 50%) of the control plane delay to establish the required radio bearers for all the involved devices together with the respective reduction of the signaling overhead. This is because of the reduction of the interactions with the core network entities and the provision of service-layer information in the Session Request message from the initiating device that facilitate the faster establishment of radio bearers for all involved devices. Within this control plane latency all the involved devices have been informed about the new service and all the required radio bearers have been established together with the radio paths. In addition, initial user plane resources have been provided within this control plane phase, something that is very useful for emergency services.

In a second possible implementation form of the communication device according to the second aspect as such or according to the first implementation form of the second aspect, the radio controller is configured to receive a notification message from the BS, wherein the notification message comprises information about a specific service initiated by a session request message of another communication device.

Receiving the notification message provides the advantage that the communication device can avoid transmission of an own request for the same service event, thereby reducing the signaling overhead.

In a third possible implementation form of the communication device according to the second implementation form of the second aspect, the radio controller is configured to transmit the session request message to the base station only if the information about the specific service comprised in the session request message differs from the information about the specific service comprised in the notification message.

This provides the advantage that the session request message is only transmitted when establishment of a new service is required, thereby reducing signaling traffic and saving radio resources.

In a fourth possible implementation form of the communication device according to the third implementation form of the second aspect, the radio controller is configured to transmit the session request message to the base station if the type of the specific service is the same for both the notification message and the session request message, but a number of communication devices involved in the specific service is different for the notification message and the session request message.

This provides the advantage that the session request message is only transmitted when establishment of a new service is required or when a change in an existing service has occured, thereby reducing signaling traffic and saving radio resources.

In a fifth possible implementation form of the communication device according to the second aspect as such or according to any of the preceding implementation forms of the second aspect, the information about the configuration of the radio path comprises at least one of: a session identifier that uniquely identifies a session for providing the specific service, configuration information for an established plurality of radio bearers, information for configuration of radio interface layers of the communication device, information and identifiers from a radio bearers mapping table of the BS, control plane resources for transmission of a radio path configuration complete message, allocated user plane resources for initial data plane transmission.

This provides the advantage that the information about the configuration of the radio paths can be agreed between the communication device and the corresponding BS. The communication device can confirm the successful completion of the configuration of the radio paths according to the requested features of the service.

In a sixth possible implementation form of the communication device according to the second aspect as such or according to any of the preceding implementation forms of the second aspect, the radio controller is configured to establish a communication with another communication device based on a local end-to-end radio data path between the communication device and the other communication device.

This provides the advantage that the radio path formation and configuration can be flexibly enhanced to other, e.g. neighboring communication devices, thereby enlarging the geographic area in which the service is offered or supporting a handover scenario where the communication device moves from a first radio cell to a second radio cell.

In a seventh possible implementation form of the communication device according to the second aspect as such or according to any of the preceding implementation forms of the second aspect, the communication device is associated by the specific service with a group of communication devices located within a geographical service area in which the specific service is provided.

This provides the advantage that the service can be offered to a group of communication devices that are located within a specific geographic area. Hence, a service such as collision detection and/or avoidance can be offered to each vehicle within the geographic area. This allows efficient performance of the service.

According to a third aspect, the embodiments of the invention relate to a method for enabling radio bearers' establishment and radio path formation to support end-to-end transmission of localized data among a group of communication devices, in particular machine-type communication (MTC) devices, the method comprising: receiving, by a radio controller, a session request message from a communication device of the group of communication devices, wherein the session request message comprises information about a specific service; and establishing, by the radio controller, a plurality of radio bearers among the group of communication devices and forming, by the radio controller, a plurality of radio paths over the plurality of radio bearers according to the information about the specific service to support end-to-end transmission of localized data between the communication devices of the group of communication devices.

Such a method is suitable to support the needs for very fast establishment of end-to-end radio bearers and the fast transmission of localized data traffic in an efficient way. In particular the BS supports localized services for the data communication among the involved devices. The specific service may be a service provided for a group of communication devices that are localized within a specific geographic area, e.g. vehicles within a specific distance with respect to each other.

According to a fourth aspect, the embodiments of the invention relate to a method for radio paths establishment and formation, the method comprising: transmitting, by a radio controller of a communication device, in particular a machine-type communication (MTC) device, a session request message to a base station, wherein the session request message comprises information about a specific service; receiving, by the MTC device, a radio paths configuration message from the BS, wherein the radio paths configuration message comprises information about a configuration of a radio path; and forming and configuring, by the MTC device, the radio path according to the information comprised in the radio paths configuration message.

Such a method is suitable to support the needs for very fast establishment of end-to-end radio bearers and the fast transmission of localized data traffic in an efficient way. In particular the method supports localized services for the data communication among the involved devices.

According to a fifth aspect, the embodiments of the invention relate to a method for enabling fast Radio Bearers' establishment and Radio Path Formation to support fast and e2e transmission of localized data among a group of MTC devices that participate in the same service.

In a first possible implementation form of the method according to the fifth aspect, the method comprises the appropriate signaling that the initiating MTC device transmits to the BS with the request to enable the fast establishment of the local end-to-end radio paths that will support the localized communication among the involved MTC devices for a session-based service (Session Request). This message includes information elements about the type of the service, the location of the transmitting device, the involved devices in the service, application layer information (e.g., payload of first transmitted message) and channel quality information of the transmitting device (e.g., RSRP, CQI).

In a second possible implementation form of the method according to the fifth aspect, the method comprises the notification message that the BS sends to MTC devices of the cell to prevent the transmission of multiple requests for the same event (service) by other MTC devices that are involved in the same service (Notification for Session Request). The identifiers of these MTC devices together which information that describe the triggered service (received by the Session Request message in method 2, or other entity or message exchange) are included in this message.

In a third possible implementation form of the method according to the fifth aspect, the method further comprising the structure, the update and the maintenance of the Radio Bearers Mapping Table at the BS that links the UL and DL Radio Bearers in the same (and/or neighboring) BS(s) for various transmission modes (unicast, multicast). This Radio Bearers Mapping Table facilitates fast data plane transmissions and data forwarding. A unique identifier is generated to describe a specific session that is triggered. All radio bearers that are created to support unicast and multicast transmissions are associated with the unique session identifier.

In a fourth possible implementation form of the method according to the fifth aspect, the method comprises the Radio bearers' establishment and Radio Paths configuration signaling that is transmitted from the BS to each MTC device involved in the specific MTC service (Radio Paths Configuration). The fields of this message include, but are not limited to: The session identifier that uniquely identifies the specific service and session. RadioBearersConfiguration Information for the establishment of Radio Bearers and (updated) configuration of the different layers (MAC, RLC, PDCP . . . ) for the radio interface. Information and Identifiers from the Radio Bearers Mapping Table that is useful for the transmission of (unicast or multicast) data traffic over the local Radio data Paths. Control plane resources for the transmission of the Radio Path Configuration Complete message. The allocated user plane resources for the quick data plane transmission for the initial steps of the specific MTC service.

In a fifth possible implementation form of the method according to the fifth aspect, the method further comprises the confirmation message that is transmitted by each involved MTC device to confirm the successful completion of the establishment of the new Radio Bearers and configuration of the Radio Paths for the MTC Service (Radio Path Configuration Complete). The fields of this message include the unique identifier of the session and the unique identifier of the transmitting device indicating the outcome, e.g. a success or a fail.

In a sixth possible implementation form of the method according to the fifth aspect, the method comprises the signaling to identify whether an additional (or more) Session Request(s) that have been received at the BS from different MTC devices (in the same geographical area and for the same service) are referring to the same event and consequently should be supported and handled in the context of the same session (i.e., create and link the radio bearers among all involved devices). The Session Merge Request message is sent from the BS to the device(s) that has sent a Session Request and the fields include information that describe the session that are already supported by the BS (i.e., unique session identifier, service type, identifiers of Involved devices).

In a seventh possible implementation form of the method according to the fifth aspect, the method comprises the response from the involved devices about their confirmation (or not) to merge the handling of different sessions (Session Merge Response). The fields of this message include the Session ID and the response from the MTC device, i.e. accept or reject.

According to a sixth aspect the embodiments of the invention relate to signaling method, where neighboring BSs (or cells) collaborate for the establishment of the local e2e Radio Paths to support devices that are attached or located at neighboring BS. The following messages are exchanged among the BSs:

Inter-node Session Request which transmits the Session Request that the source BS has received to the neighboring cell (Target BS) in order to proceed to the local admission control, Radio Bearers Mapping Table update and the quick allocation of resources. The content of this message includes but is not limited to: Session identifier, Initiating MTC device identifier, Initiating device position, MTC Service type, IDs of MTC devices involved in the service.

Inter-node Session Response is sent from the Target BS to the Source BS to confirm the availability (e.g., in terms of resources) of the Target BS in the specific MTC service. The content of this message includes but is not limited to: session ID, list of the IDs of involved devices located (or attached) at the Target BS, the admission (or not) for each involved device to participate in the service and “RB Mapping Table Information” of the Target BS that are relevant to the specific service (i.e., Session ID).

After the successful completion of radio bearer management the Source BS transmits to the Target BS(s) a confirmation message for the successful completion of the required steps (Inter-node Session Confirmation). In this message the Session ID is described as well as the “RB Mapping Table Information” of the Source BS for the update of the RB Mapping Table of the Target BS.

According to a seventh aspect the embodiments of the invention relate to a method for signaling between the BS and an MTC Server (located at the BS or as a separate entity) to receive application-layer service information that is used e.g., for the admission control, the calculation and planning of required resources (Session Configuration Request and Session Configuration messages). The method comprises: Periodic Reporting of location or status information from the MTC devices could be periodically sent to the MTC Server or to the BS. The MTC Server may also directly sent to the BS a Session Configuration or even a Session Request for the establishment of local end-to-end Radio Path among the involved devices.

According to an eighth aspect the embodiments of the invention relate to a GeoNetworking Address (GeoAddress) method indicating the service area and consequently establishing the radio paths among the MTC devices that belong in the area that the GeoAddress describes. The Session Request and the Notification for Session Request can include the GeoAddress (instead of the IDs of involved devices). The GeoAddress includes the fields but is not limited to the position vector of the initiating MTC device, the latitude and the longitude of the selected geometric shape as well as the distances and the angle of the geometric shape.

In a first possible implementation form of the method according to the eighth aspect, the method comprises the signaling to discover to the IDs of the involved MTC Devices based on the GeoAddress description, which are required for dedicated Radio Bearers' establishment and Paths formation. This signaling is transmitted: a) Between the BS(s) and the MTC devices that are attached in the corresponding cell (Session Update message is the response of the MTC devices to the BS); b) Between the BS(s) and the MTC Server.

### BRIEF DESCRIPTION OF THE DRAWINGS

Further embodiments of the invention will be described with respect to the following figures, in which:

FIG. 1 shows a schematic diagram of a communication system 100 illustrating MTC devices and base stations interfaces according to an implementation form;

FIGS. 2a and 2b show schematic diagrams of communication systems 200a, 200b illustrating local end-to-end radio paths using (a) uplink (UL and unicast downlink (DL) dedicated radio bearers (DRB) and (b) UL and multicast DL DRB bearers according to an implementation form;

FIG. 3 shows a schematic diagram of a communication system 300 illustrating the structure of the radio bearers mapping table for uplink (UL) and unicast downlink (DL) dedicated radio bearers (DRB) according to an implementation form;

FIG. 4 shows a schematic diagram of a communication system 400 illustrating the structure of the radio bearers mapping table for uplink (UL) and multicast downlink (DL) dedicated radio bearers (DRB) according to an implementation form;

FIG. 5 shows a schematic diagram of a communication system 500 illustrating message sequences for fast radio bearers establishment and local radio paths formation according to an implementation form;

FIG. 6 shows a message sequence diagram of a communication system 600 illustrating signaling for single cell fast radio bearers' establishment and path formation according to an implementation form;

FIG. 7 shows a message sequence diagram of a communication system 700 illustrating signaling for multi-cell fast radio bearers' establishment and path formation according to an implementation form;

FIG. 8 shows a message sequence diagram of a communication system 800 illustrating signaling for fast radio bearers' establishment and path formation using Geo-Address according to an implementation form;

FIG. 9 shows a message sequence diagram of a communication system 900 illustrating signaling and interaction between the MTC devices and the base stations with an MTC server according to an implementation form;

FIG. 10 shows a message sequence diagram of a communication system 1000 illustrating fast radio bearer establishment and radio path formation for an MTC service in an LTE network according to an implementation form;

FIG. 11 shows a schematic diagram of a communication system 1100 including a base station 110 according to an implementation form and a group of communication devices 130, 140, 150, e.g. MTC devices according to an implementation form; and

FIG. 12 shows a schematic diagram of a communication system 1200 including a communication device 150, e.g. an MTC device according to an implementation form communicating with a BS 110 according to an implementation form.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

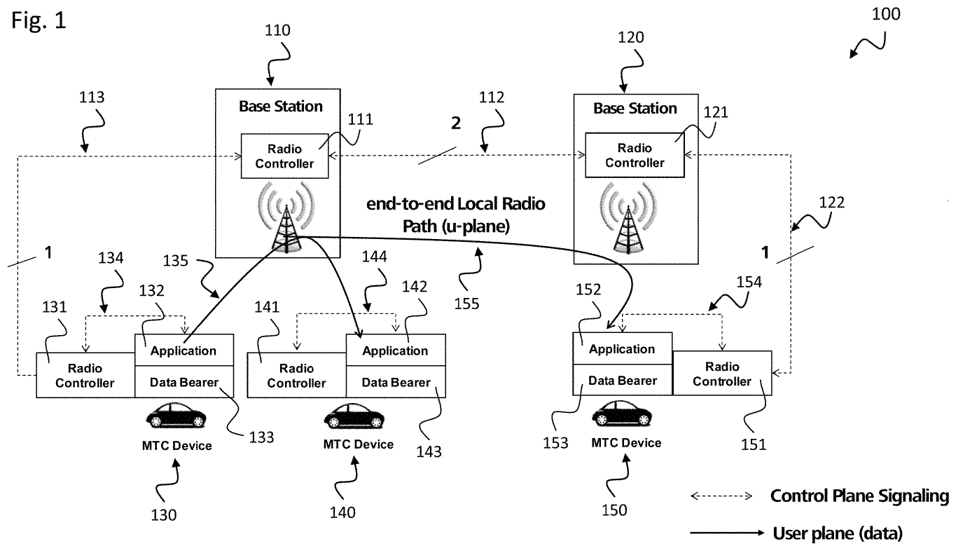

FIG. 1 shows a schematic diagram of a communication system 100 illustrating MTC devices and base stations interfaces according to an implementation form. The communication system 100 includes a first base station (BS) 110, a second base station 120 and a group of communication devices 130, 140, 150, e.g. MTC devices. The base stations 110, 120 and the group of communication devices 130, 140, 150 exchange signaling (c-plane, control-plane) messages 113, 112, 122 and data (u-plane, user-plane) messages 135, 155. Each BS 110, 120 and each communication device 130, 140, 150 include a radio controller 111, 121, 131, 141, 151 and each communication device 130, 140, 150 further includes an application layer 132, 142, 152 and a data bearer layer 133, 143, 153. The application layers 132, 142, 152 are configured to communicate with the respective radio controllers 131, 141, 151 via signaling messages 134, 144, 154.

In one exemplary communication establishment, the radio controller 111 of first BS 110 is configured to receive a signaling message 113, including a session request message as described below from a communication device, e.g. the first communication device 130 of the group of communication devices 130, 140, 150. The session request message 113 includes information about a specific service. The radio controller 111 is configured to establish a plurality of radio bearers 135, 155 among the group of communication devices 130, 140, 150 and to form a plurality of radio paths over the plurality of radio bearers 135, 155 according to the information about the specific service to support end-to-end transmission of localized data between the communication devices 130, 140, 150 of the group of communication devices 130, 140, 150 as described in the following.

The radio controller 131 of a respective communication device 130 is configured to transmit a signaling message 113 including a session request message as described below, to a base station, e.g. the first base station 110. The session request message 113 includes information about a specific service, e.g. as described below. The radio controller 131 is further configured to receive a radio paths configuration message, e.g. via the signaling message 113, from the BS 110. The radio paths configuration message includes information about a configuration of a radio path 135. The radio controller 131 is further configured to form and configure the radio path 135 according to the information comprised in the radio paths configuration message, e.g. as further described below.

The Session Request denotes the request message that is transmitted by an MTC device 130, 140, 150 (e.g., vehicle, robot etc) to establish the end-to-end radio bearers 135, 155 among a group of devices that participate in the same application-layer service (e.g., V2X Service), The Session Request enables the required QoS features and communication modes (unicast, multicast, broadcast), according to the requirements of the application-layer service. A Session Request message that is transmitted by an individual device can directly trigger the establishment of the radio bearers 135, 155, the radio paths as well as the configuration process for all the MTC devices 130, 140, 150 that are involved in the specific service (Interface 1, in FIG. 1). The involved MTC devices 130, 140, 150 are explicitly described in the Session Request message or alternatively they may be retrieved from MTC Servers located at the BS 110 or at another entity. In addition to the above-mentioned advantages, the required signaling is reduced by avoiding the transmission of multiple Session Request messages by the different involved devices 130, 140, 150 for the same V2X Service. Moreover, together with the (control plane) signaling 113, 112, 122 for radio bearers' 135, 155 establishment, and specifically together with the configuration phase of the involved MTC devices 130,140,150, the (data plane) radio resources are also reserved and allocated to the corresponding MTC devices 130, 140, 150 for the initial steps of the MTC service to support fast u-plane transmissions.

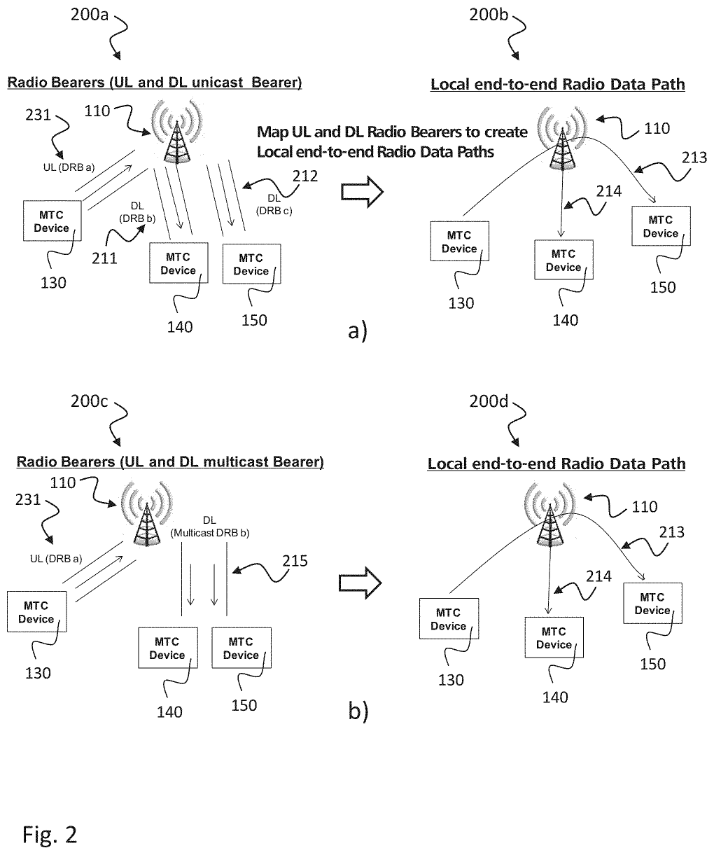

FIGS. 2a and 2b show schematic diagrams of communication systems 200a, 200c illustrating local end-to-end radio paths 200b, 200d using (a) uplink (UL) and unicast downlink (DL) dedicated radio bearers (DRB) 200a and (b) UL and multicast DL DRB bearers 200c according to an implementation form.

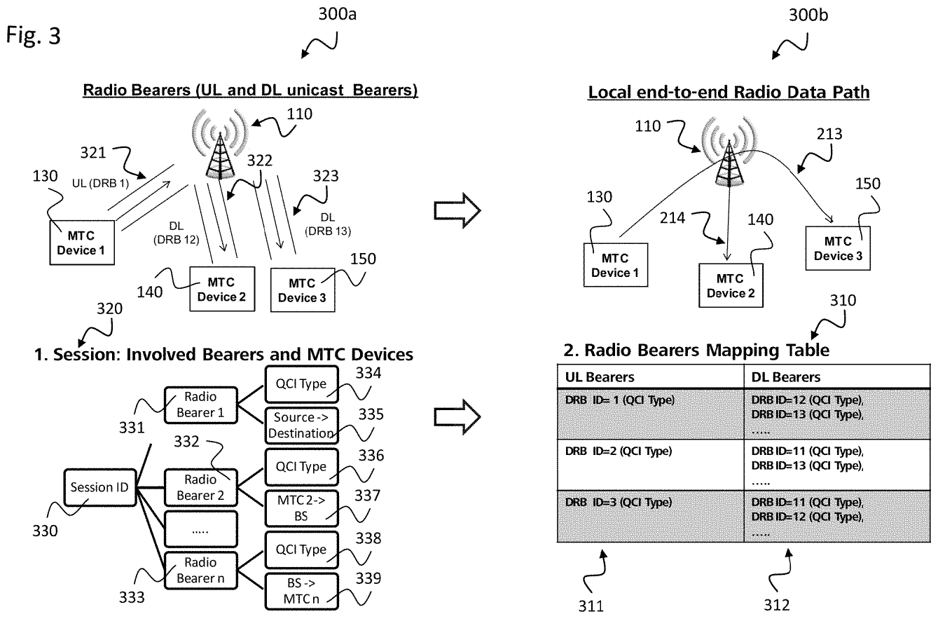

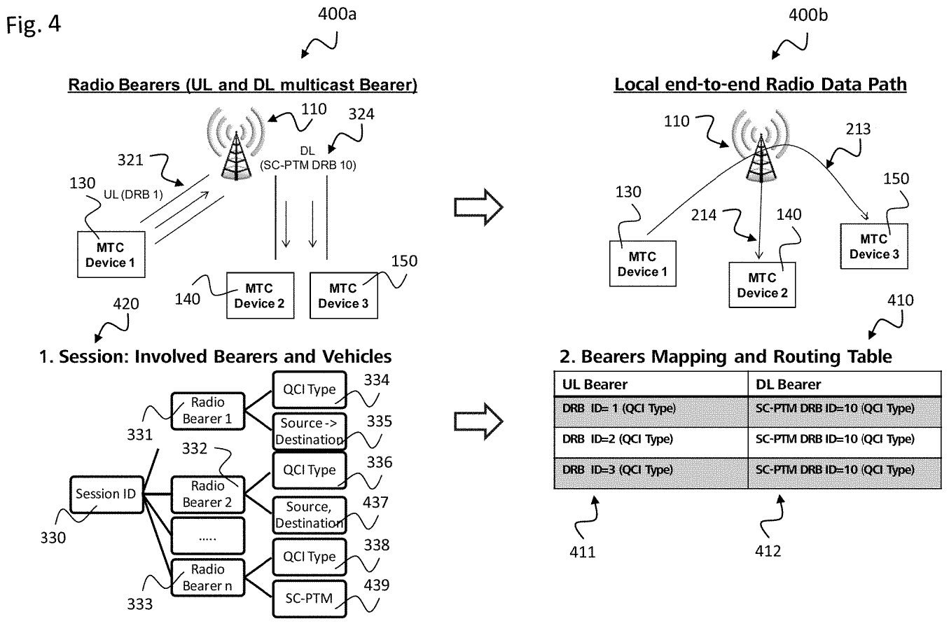

For the above-mentioned second problem that is addressed in this disclosure, i.e., efficient formation and maintenance of end-to-end radio data paths for localized services supporting different QoS requirements and communication modes (unicast, multicast, broadcast)), new methods and signaling is introduced at the BSs to support the efficient formation and management of local end-to-end radio data paths that will allow the fast and reliable transmissions of localized data traffic among the involved devices, satisfying their QoS requirements and the characteristics of the MTC services (e.g., different transmission modes in the same service). The “end-to-end” term denotes that the (u-plane) radio data paths are established among the involved communicating end devices (e.g., vehicles, robots), while the “local” term denotes that they are established by (and via) the BSs, since the data traffic is localized (i.e. the nodes of the core network are not necessary to participate in the u-plane transmissions). For that reason, a “Radio Bearers Mapping Table” (RBMT) is created and maintained at the BS, based on new Session Requests for the creation of the local end-to-end radio data paths. These end points of the radio paths can belong to a single cell or different neighboring cells (multi-cell radio data path). The Radio Bearers Mapping Table of the BS maps and connects the uplink and downlink radio bearers (in case of cellular interface) to enable fast and reliable transmission of localized data traffic for different transmission modes (unicast, multicast, broadcast) and session (bearers) management. One example of the mapping is depicted in FIG. 2. The uplink (UL) Radio Bearer 231 can be linked with downlink (DL) radio bearers 211, 212, 215, either unicast for DL DRB b 211 and DL DRB c 212 as shown in FIG. 2a) or multicast for DL Multicast DRB b 215 e.g., SC-PTM Radio Bearer as shown in FIG. 2b). The Radio Bearers Mapping Table of the BS does not require IP addresses and there is no need for the MBMS to support the multicast/broadcast traffic, with the direct benefit of lower latency. The structure and the information that are kept at the Radio Bearers Mapping Table are described below with respect to FIGS. 3 and 4.

As it is mentioned above, the BS creates and maintains a Radio Bearers Mapping Table that maps/links the UL 231 and DL bearers 211, 212, 215 for local Radio Paths Formation and the fast forwarding of localized data traffic. The different dedicated Radio Bearers that are formed for all involved MTC devices 130, 140, 150 for the specific service are grouped under the same Session ID, to facilitate session updates' (e.g., add new MTC Device in the context of the same session). A unique Session ID is initially derived with the reception of the Session Request message by the BS to describe uniquely the specific service session (e.g., considering the type of service, the involved devices etc.).

The dedicated UL 231 and DL 211, 212, 215 Radio Bearers of different MTC devices 130, 140, 150 that are created in the context of the same Service (i.e., same session ID) are linked at the BS 110 level to create the local data paths 213, 214, and support the faster forwarding/routing of the data packets from the source MTC device, e.g. 130 to the destination MTC device(s), e.g. 140, 150 based on the transmission type (e.g., unicast, multicast) and QoS features. Each Dedicated Radio Bearer (DRB) 231, 211, 212, 215 is described by an identifier (DRB ID), the Source and Destination node (e.g., for UL DRB Source: MTC Device ID, Destination: BS ID, while for DL DRB Source: BS ID, Destination: MTC Device ID) and the QoS Class Identifier (QCI) that defines the QoS features of the Radio Bearer (e.g., supported latency, data rate, reliability KPIs etc.). FIGS. 3 and 4 described in the following present two examples of the structure of a Radio Bearers Mapping Table that may be located at the BS 110 in order to build the data paths 213, 214 to support the MTC data traffic.

FIG. 3 shows a schematic diagram of a communication system 300 illustrating the structure of the radio bearers mapping table for uplink (UL) and unicast downlink (DL) dedicated radio bearers (DRB) according to an implementation form.

In FIG. 3 for each MTC device 130, 140, 150 that is involved in the specific service an UL RB 321 and a DL RB 322, 323 are created based on the QoS of the respective service. In the Radio Bearers Mapping Table 310 the UL Radio Bearer 311 of each MTC Device, e.g. MTC device 1 is mapped with the DL Bearers 312 of other involved MTC Devices (e.g., MTC Device 2, 3, . . . n) to support e2e multicast and/or unicast transmissions. Hence, each row of the Radio Bearers Mapping Table 310 includes the RB 311 of the source MTC device 130 of a local radio path and the RBs 312 of the Destination MTC devices 140, 150.

A session 320 is initiated with involved bearers 321, 322, 323 and MTC devices 130, 140, 150. The session 320 is indicated by a session ID 330, the involved radio bearers 331, 332, 333 and each involved radio bearer is indicated by a QCI type 334, 336, 338 and routing information such as source-to-destination 335, MTC2 to BS 337 or BS to MTCn 339.

FIG. 4 shows a schematic diagram of a communication system 400 illustrating the structure of the radio bearers mapping table for uplink (UL) and multicast downlink (DL) dedicated radio bearers (DRB) according to an implementation form.

On the other hand, In FIG. 4 a SC-PTM radio bearer 324 is created by the BS 110 for the DL multicast transmissions. In this case the Radio Bearers Mapping Table 410 connects the UL DRBs 411 of each involved device with the SC-PTM Radio Bearer 412 (i.e., Group Bearer). In the case that multiple cells are involved then the local radio path will be extended in neighboring BSs (not shown in FIG. 4). The Radio Bearers Mapping Table 410 will include in the “DL Bearers” column 412 the ID(s) of the DL DRB 324 of neighboring BS together with its identifier/address.

A session 420 is initiated with involved bearers 321, 324 and MTC devices 130, 140, 150. The session 420 is indicated by a session ID 330, the involved radio bearers 331, 332, 333 and each involved radio bearer is indicated by a QCI type 334, 336, 338 and routing information such as source-to-destination 335, 437 or SC-PTM 439.

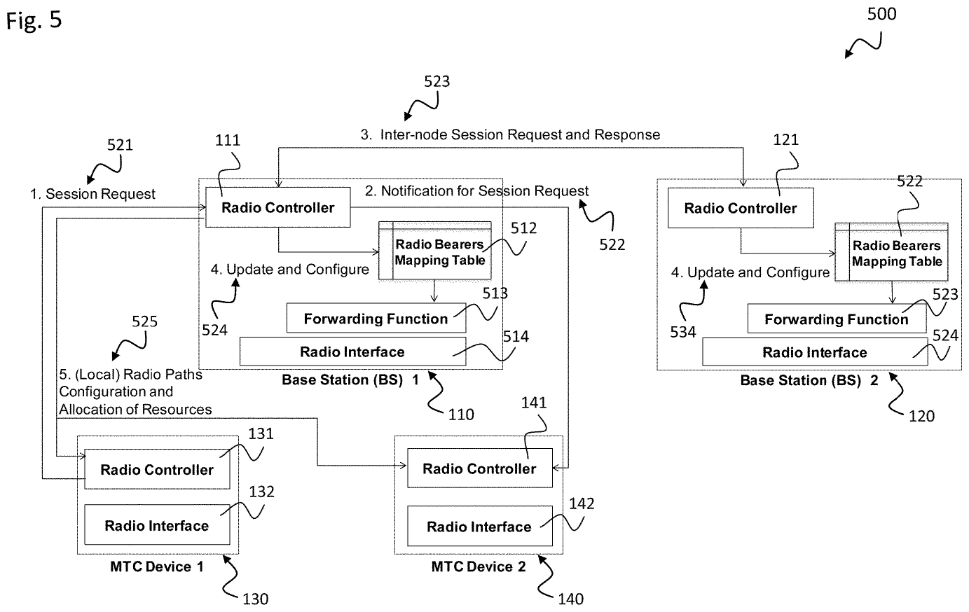

FIG. 5 shows a schematic diagram of a communication system 500 illustrating message sequences for fast radio bearers establishment and local radio paths formation according to an implementation form.

With the triggering of an MTC event, one of the devices, e.g. MTC device 1, 130 transmits to the BS 110 a Session Request message 521 to establish new radio bearers (due to an event or to triggering condition) that will enable the fast data plane transmissions and localized communication for a (session-based) MTC service with low delay and high reliability requirements. This message 521 provides the necessary information (e.g. service information, list of involved devices, communication layer info etc.) to assist the admission control which checks the availability of resources for all the involved devices 130, 140, 150 and then proceeds to the establishment of the appropriate radio bearers and local end-to-end radio paths. The unique Session ID is initially derived by the Radio Controller 111 that is located in the BS 110, to describe uniquely as mentioned above the specific service session (e.g., considering the type of service, the involved devices etc.). Then a notification message 522 is transmitted from the BS 110 that describes the received Session Request 521 to avoid multiple requests for the same service event by the other involved devices 140, 150 and thus reduce the signaling overhead (Notification for Session Request, 522). After the successful admission control for the specific service, the Radio Controller 111 of the BS 110 creates the appropriate radio bearers based on the QoS features of the service. Thereinafter, the Radio Controller 111 maps and connects the different radio bearers (e.g., uplink, downlink) creating the local end-to-end radio data paths (Step 4, 524). The Radio Bearers Mapping Table 512 at the BS 110 is updated and configured with this information 524, and facilitates the fast transmission and forwarding of user data (data plane). The formed paths traverse the same (or neighboring) BS(s) 110, supporting different transmission modes (unicast, multicast). The BS 110 together with the e2e radio bearers' establishment, schedules also user plane resources to enable the quick u-plane (local) transmission among the involved devices 130, 140, 150 in the cell 110. The allocated u-plane resources are described in the messages that are sent at the control plane as a reply to the Session Request message 521 (i.e., Radio Paths Configuration and Allocation of Resources, 525), avoiding additional scheduling request delay. In the same message 525, information for the establishment of Radio Bearers and the Radio Paths is transmitted.

In the case that the MTC devices 130, 140, 150 are located/attached at different cells 110, 120, then the direct interaction among the neighboring BSs 120 is needed for the creation and the update of the Radio Bearers Mapping Table 512 and the formation of the local paths (Inter-node Session Request and Response, 523). The Source BS 110 (i.e., BS 110 that the initiating MTC device is located) sends to the neighboring BS 120 (Target BS) information that describe the triggered session (e.g., initiating device ID, service information, list of involved devices, communication layer info, etc.). Based on the availability of the u-plane resources to support the QoS requirements the Target BS 120 sends the Inter-node Session Response message 523 to trigger the configuration of the Radio Bearers among neighboring cells 110, 120 and the multi-cell radio paths. Through these messages 523 the BSs 110, 120 exchange configuration parameters (e.g., Radio Bearers IDs) for the update of the individual Radio Bearers Mapping Tables 512, 522.

Different configurations can be supported: a) with or without periodic reporting of devices' location and/or status to the radio access network or to an MTC Server, b) different methods for the identification of involved devices in a specific service can be used, based on the IDs of involved devices or with a Geo-Network Description (GeoAddress), c) devices are located to a single cell or to multiple cells.

With the disclosed technique there is an important reduction (more than 50%) of the control plane delay to establish the required radio bearers for all the involved devices together with the respective reduction of the signaling overhead. This is because of the reduction of the interactions with the core network entities and the provision of service-layer information in the Session Request message 521 from the initiating device 130 that facilitate the faster establishment of radio bearers for all involved devices 130, 140, 150. Within this control plane latency all the involved devices 130, 140, 150 have been informed about the new service and all the required radio bearers have been established together with the radio paths. In addition, initial user plane resources have been provided within this control plane phase, something that is very useful for emergency services.

An additional benefit of this disclosed technique, because of the concept of the local end-to-end radio data paths and the introduction of the Radio Bearers Mapping Table at the BS, is the faster user plane (u-plane) transmission of the data traffic (e.g., V2X traffic) due to the localized communication, and the absence of the need of the IP protocol procedures and any interaction with the MBMS entities. Moreover, the initial allocation of the u-plane resources in the context of the control plane signaling for bearers' establishment, reduces further the communication delay and the signaling overhead because of the scheduling requests and grants that are not exchanged between the involved devices 130, 140, 150 and the BS 110 for the initial steps of the MTC service (i.e., reduce signaling and delay for BSR and Uu Grants in LTE).

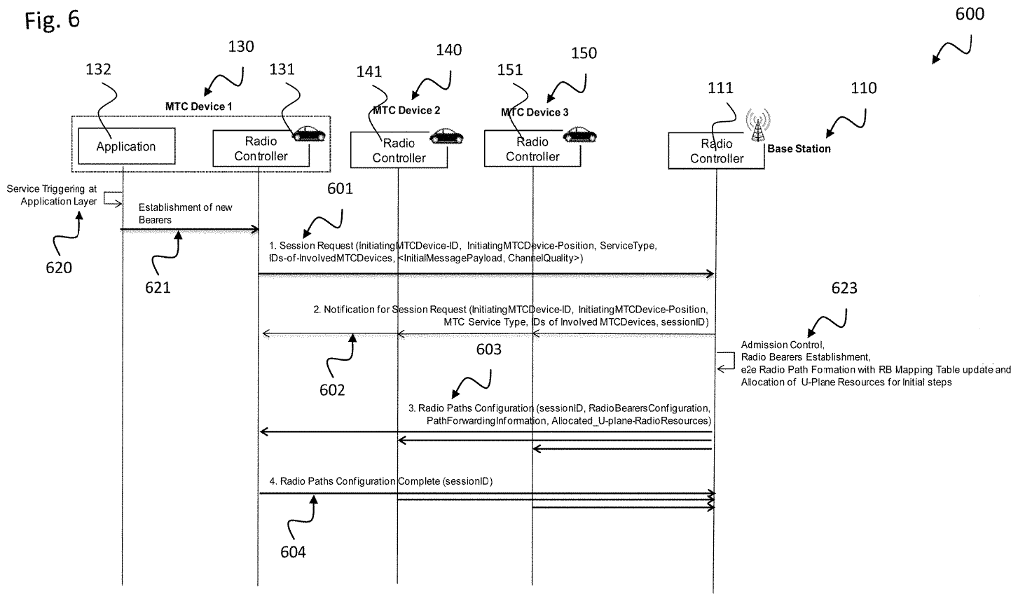

FIG. 6 shows a message sequence diagram of a communication system 600 illustrating signaling for single cell fast radio bearers' establishment and path formation according to an implementation form. The message sequence diagram shown in FIG. 6 describes an exemplary scenario of Fast Radio Bearers' Establishment and Path Formation Signaling. After Service Triggering 620 at application layer 132 of an MTC device, for example the MTC device 1, 130 shown in FIG. 6, a message for “Establishment of new Bearers” 621 is sent to the radio controller 131 of the MTC device 130 to initiate the following procedure.

When a service is to be offered (e.g., lane merging, cooperative collision avoidance are examples of Vehicular services), the initiating MTC device 130 (i.e. its Radio Controller 131) sends a Session Request message 601 to the BS 110 (i.e. its Radio Controller 111) in order to: check the availability of resources, establish the radio bearers, form the local end-to-end radio data paths (through the configuration of the Radio Bearers Mapping Table of the BS) and reserve the u-plane radio resources that are required based on the (application layer) signaling/steps of the specific service. The content of the Session Request message includes: 1) The ID (“InitiatingMTCDevice-ID”) and the location of the initiating MTC device (“InitiatingMTCDevice-Position”). 2) The type of Service (“Service Type”), which provides to the BS 110 the required QoS information (e.g., multicast/unicast, u-plane delay and reliability requirements). The “Service Type” is a key indicator for the required QoS features, the expected resources and the required radio bearers that will be established and how they will be configured (e.g., Cooperative Collision Avoidance in a V2X Service). 3) The IDs of the other involved MTC devices 140, 150 in the specific service (“IDs-ofinvolvedMTCDevices”), which are useful for the calculation of expected resources and the identification of the radio bearers that are required for the session of the specific service. 4) The “<InitialMessagePayload, Channel Quality>” provides information to the BS 110 required for the (quick) allocation of data plane resources for the first message(s) that will be transmitted. This is very useful in the case of urgent service (e.g., emergent trajectories alignment in V2X). The payload of (initial) transmitted data packet and the signal quality information of the initiating device (CQI or other channel quality indicators can be used e.g., RSRP) together with other information of the Session Request are used for the calculation of the required u-plane Resources for initial steps of the data traffic.

With the reception of the Session Request 601 the BS 110 (i.e. its Radio Controller 111) sends a Notification for Session Request message 602 in order to notify the MTC devices 130, 140, 150 in the same geographical area (e.g., cell area) about the already transmitted Session Request 601 and thus to avoid the transmission of multiple Session Request messages 601 for the same reason/event by different involved MTC devices 130,140, 150. This message 602 includes all this information that is required in order to identify the service (i.e. information that is also included in the initial Session Request 601). The repetition rate of the Notification for Session Request 602 may be configurable.

The Radio Controller 111 at the BS 110 based on the information received by the Session Request 601 (i.e. Service Type, number or involved devices) undertakes to execute the following steps 623 in order to support the service: 1) Initially, a SessionID is generated, at the BS 110 for each served service (more information for this phase is presented below). 2) Then, it checks whether it has the required resources to support the requested service based on the requirements and features of the service (Admission Control phase). 3) In the case that there are available resources, the required uplink and downlink Radio Bearers are established, which are linked to create the different local end-to-end radio paths, e.g. as described above with respect to FIGS. 3 and 4. The creation of the Radio Bearers' Radio Bearers Mapping Table, e.g. the tables 512, 522 as described above with respect to FIG. 5, used for the management of the local traffic flow, is configured and updated appropriately. This Radio Bearers Mapping Table update creates the (Multicast and Unicast) end-to-end radio paths for fast u-plane transmission, e.g. as described above with respect to FIGS. 3 and 4. 4) The next step includes the reservation of the resources for the initial transmissions/steps. These resources are reserved and transmitted to the involved MTC devices 130, 140, 150 together with other information that is needed for the configuration of the radio bearers, the local e2e radio paths and the communication modules of the MTC devices. UL (and DL) resources allocated for (user plane) transmission only for the first steps of the service to provide the capability for initial fast u-plane transmission. This is an important feature, especially for emergency situations (e.g., V2X collision avoidance).

The Radio Paths Configuration message 603 is transmitted to each involved MTC device 130, 140, 150, as a response to the above procedures and the Session Request 601. This message 603 includes: 1) Session ID: uniquely identifies the specific session. 2) RadioBearersConfiguration: Information for the establishment of Radio Bearers and (updated) configuration of the different layers (e.g., Physical Layer, Medium Access Layer) of the radio interface in order to support the specific service. 3) PathForwardingInformation: includes any identifiers from the Radio Bearers Mapping Table, e.g. the tables 512, 522 as described above with respect to FIG. 5, that is useful for the transmission of (unicast or multicast) data traffic over the local radio data paths (e.g., identifiers for group of MTC devices, or individual MTC devices). 4) Control plane resources for the transmission of the completion message (Radio Paths Configuration Complete 604). 5) Allocated u-plane Radio Resources: Scheduled Radio Resources for initial steps of the specific service.

The involved devices 130, 140, 150 confirm the successful completion of the establishment of the new bearers and configuration for the service with the Radio Paths Configuration Complete message 604. After this step, the involved MTC devices 130, 140, 150 can exchange their data plane traffic, according to the requested QoS features of the service.

If multiple Session Request messages 601 arrive at the BS 110 for the same Service Type (“Service Type”) and with exactly the same list of involved devices (“IDs-ofInvolvedMTCDevices”), exactly in the period between the transmission of the Session Request 601 and the reception of Notification for Session Request 602 (from MTC devices 130, 140, 150 in the cell), then the BS 110 combines the two sessions requests 601 under the same sessionID. In the case that one of the devices in the cell sends a request for the same Service type but with a different list of involved devices then this device is forced to send the message to the BS 110 and is not blocked by the notification message (i.e., Notification for Session Request 602). With the reception of the message the BS 110 asks the device that has sent the latest Session Request 601 to accept or not the merging process. For this case the following messages are introduced: The Session Merge Request, which includes information that describes the other Session Request (Session ID, Service Type, IDs of Involved devices); The Session Merge Response message, which includes the SessionID and the response (Accept or Reject) from the devices that received the Session Merge Request.

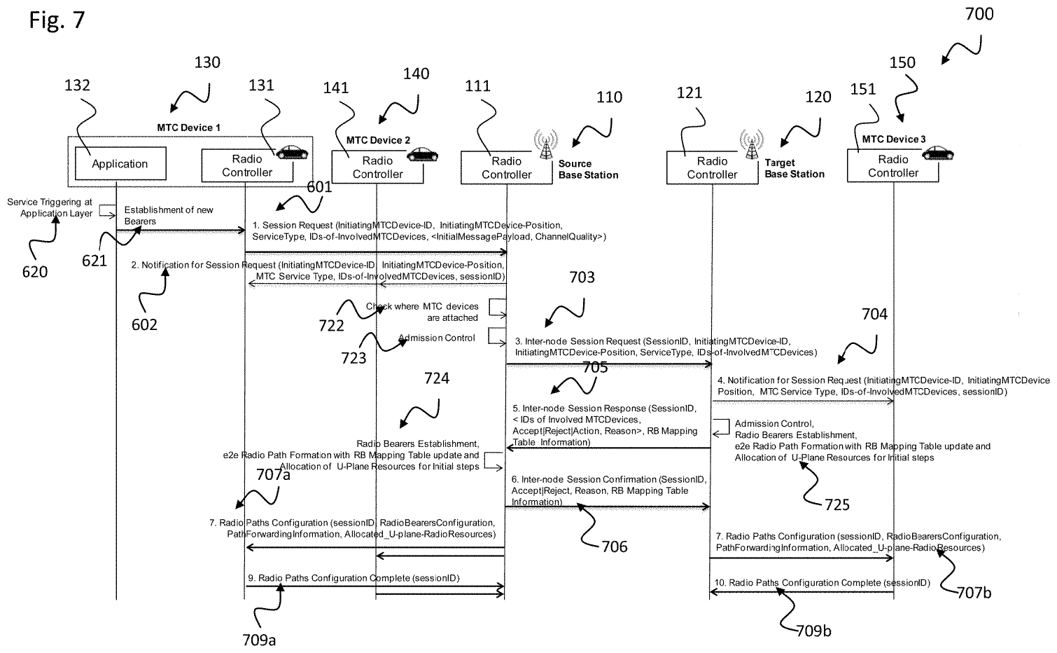

FIG. 7 shows a message sequence diagram of a communication system 700 illustrating signaling for multi-cell fast radio bearers' establishment and path formation according to an implementation form. The message sequence diagram shown in FIG. 7 describes an exemplary scenario of Multi-cell Fast Radio Bearers' Establishment and Path Formation. As described above with respect to FIG. 6, after Service Triggering 620 at application layer 132 of an MTC device, for example the MTC device 1, 130 shown in FIG. 7, a message for “Establishment of new Bearers” 621 is sent to the radio controller 131 of the MTC device 130 to initiate the following procedure.

In the case that the devices that are described in the Session Request 601 belong (i.e. are attached) to different cells 110, 120, then additional messages are exchanged among the involved cells/BSs 110, 120 for the fast end-to-end path establishment. Initially, the Source BS 110 that has received the initial Session Request 601 checks 722 whether the devices included in the message 601 are connected to the Source BS 110. The latter initially performs the local admission control 723 to check whether the required resources are available for those devices that belong to the Source BS 110. Then, for the rest of the MTC devices (e.g. MTC device 3, 150 in this example) that are attached to a neighboring BS 120 (called Target BS), the Source BS 110 sends an Inter-node Session Request 703 to the respective Target BS 120, providing the sessionID and the other information (InitiatingMTCDevice-ID, InitiatingMTCDevice-Position, Service Type, IDs-ofInvolvedMTCDevices) available from the initial Session Request 601. The Target BSs (in this example BS 120, but there may be more than one target BSs) are identified by simply forwarding the above message 703 to all neighboring BSs 120.

The Target BS(s) 120 that receives the Inter-node Session Request message 703 checks whether it has attached/connected one or more of the MTC Devices that are described in received message, and then performs all necessary steps as in the case of a single cell, as described above with respect to FIG. 6 (i.e., sends the Notification for Session Request 704 in order to notify the devices 150 under the same cell 120, performs the local Admission Control 725, establishes local unicast or multicast radio bearers for uplink and downlink etc., e.g. as described above with respect to FIGS. 3 and 4).

Thereinafter, the Target BS 120 sends to the Source BS 110 the Inter-node Session Response message 705 to confirm (or not) its availability for the formation of the local end-to-end path among the involved devices in the specific service. In this message 705 the IDs of the devices located in this cell (BS) 120 (MTC device 3, 150 in this example) are also included. In the case of rejection by the Target BS 120 then the “Inter-node Session Response” message 705 describes the reason of the rejection. This may include but are not limited to a) low availability of resources, b) delay requirements cannot be supported etc. In addition, the information of the RB Mapping Table of the Target BS 120 (e.g., DRB Identifiers, Target BS Identifier/Address) that are relevant to the specific service (i.e., Session ID) is sent to the Source BS 110 (“RB Mapping Table Information”).

With the reception of a positive Inter-node Session Response message 705 the source BS 110 establishes 724 the local radio bearers (unicast, multicast) for the uplink and downlink traffic at the Source cell 110, while the local Radio Bearers Mapping Table is also updated, e.g. as described above with respect to FIGS. 3 and 4. In this multi-cell case, the Radio Bearers Mapping Table enables the forwarding (reception) of the traffic (e.g. by the forwarding function 523 depicted in FIG. 5) to (from) the neighboring cell(s) for unicast or multicast data packets, using the RB Mapping Table Information”) that were sent via the Inter-node Session Response 705. After the successful completion of the above steps the Source BS 110 sends the Inter-node Session Confirmation message 706 to the Target BS(s) 120. In this message 706 the ID of the session is described as well as the “RB Mapping Table Information” of the Source BS 110. The Radio Bearers Mapping Table of the Target BS 120 is updated with the “RB Mapping Table Information” of the Source BS 110 (e.g., DRB Identifiers, Source BS Identifier/Address as described above with respect to FIGS. 3 and 4).

At this point, the Source BS 110 can initiate the Radio Paths Coordination, even before the reception of Inter-node Session Response message 705 from the Target BS 120, in case of an emergency situation, for example. After this step, both the Source and Target BSs 110, 120 send a Radio Paths Configuration message 707a, 707b to the involved MTC devices 130, 140, 150 and they are expecting the corresponding Radio Paths Configuration Complete messages 709a, 709b, as it is described above with respect to FIG. 6.

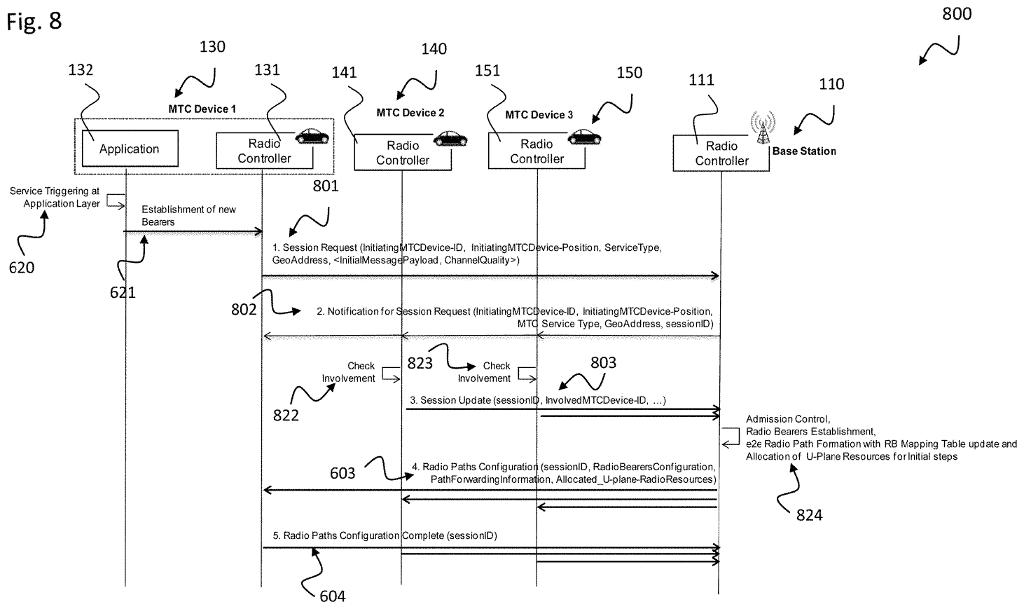

FIG. 8 shows a message sequence diagram of a communication system 800 illustrating signaling for fast radio bearers' establishment and path formation using Geo-Address according to an implementation form. The message sequence diagram shown in FIG. 8 describes an exemplary scenario of Fast Radio Bearers' Establishment and Path Formation using GeoNetworking Address. As described above with respect to FIG. 6, after Service Triggering 620 at application layer 132 of an MTC device, for example the MTC device 1, 130 shown in FIG. 8, a message for “Establishment of new Bearers” 621 is sent to the radio controller 131 of the MTC device 130 to initiate the following procedure.

In the defined method, the GeoNetworking Address may be used as an alternative approach to describe the involved MTC devices 130, 140, 150 that participate in a specific service and consequently establish the appropriate radio paths. The MTC Devices 130, 140, 150 are addressed using their geographical location (i.e. their GeoNetworking Address) instead of the IDs of the devices 130, 140, 150. Examples for the description of the GeoNetworking Addresses include but are not limited to: a) GeoBroadcast: communication from a device to all devices within a geographical target area e.g., circular area, rectangular area, ellipsoidal Area, b) GeoAnycast: communication from a device to an arbitrary device within a geographical target area. The GeoNetworking Address (“GeoAddress”) includes the following fields, but is not limited to: 1) Position of Initiating/Source MTC Device; 2) GeoAreaPosition Latitude: latitude for the center position of the geometric shape in 1/10 micro degree; 3) GeoAreaPosition Longitude: longitude for the center position of the geometric shape in 1/10 micro degree; 4) Distance a: Distance a of the geometric shape in meters; 5) Distance b: Distance b of the geometric shape in meters; 6) Angle: Angle of the geometric shape in degrees from North.

Additional signaling is needed to be introduced in order to resolve the Geo-broadcast/Geo-anycast area to the specific involved MTC devices, which is required for the establishment of the Radio Bearers and the Radio Paths. The GeoNetwork Address (i.e., (“GeoAddress”) is included in the Session Request 801 (replacing the list of the MTC devices, IDs-ofInvolvedMTCDevices of Session Request 601 described above with respect to FIG. 6). The Source BS 110 undertakes to identify the IDs of the involved devices 130, 140, 150 of the (service) area that the initiating MTC device has described. The BS 110 after the reception of the Session Request 601 transmits the Notification for Session Request 802 that corresponds to the Session Request 602 described above with respect to FIG. 6. In this case the GeoNetworking Address is used (<GeoAddress). The role of the message is twofold: a) Notification to avoid multiple concurrent requests (as described above with respect to FIG. 6); b) Triggering for the identification of the IDs of the involved devices, based on the GeoNetworking Address description.

The MTC devices that belong to the GeoNetwork area (e.g. MTC devices 2 and 3 in this example) check their involvement 822, 823 and send to the BS 110 a Session Update message 803. This is the response to the Notification for Session Request message 802 from the devices that are located in the area that is specified by the “GeoAddress”. The Session Update 803 includes the session ID and identifier of the involved device 140, 150 and other information about the service necessary for the Admission Control 824 or for the Resource Allocation. The GeoNetwork area may for example correspond to the geographical area 1115 depicted in FIG. 11 in which an exemplary number of communication devices 130, 140, 150 are located.

In the case that multiple cells are involved, then the “GeoAddress” field is added in the Inter-node Session Request message 703 (described above with respect to FIG. 7) and the Target BS 120 performs then all steps described above with respect to FIG. 7, updated with the modifications and messages presented in this section (i.e., Notification for Session Request message 802 and Session Update message 803).

Then, the Radio Paths Configuration message 603 is transmitted to each involved MTC device 130, 140, 150, as described above with respect to FIG. 6 and the respective devices answer with the completion message (Radio Paths Configuration Complete 604). As described above with respect to FIG. 6.

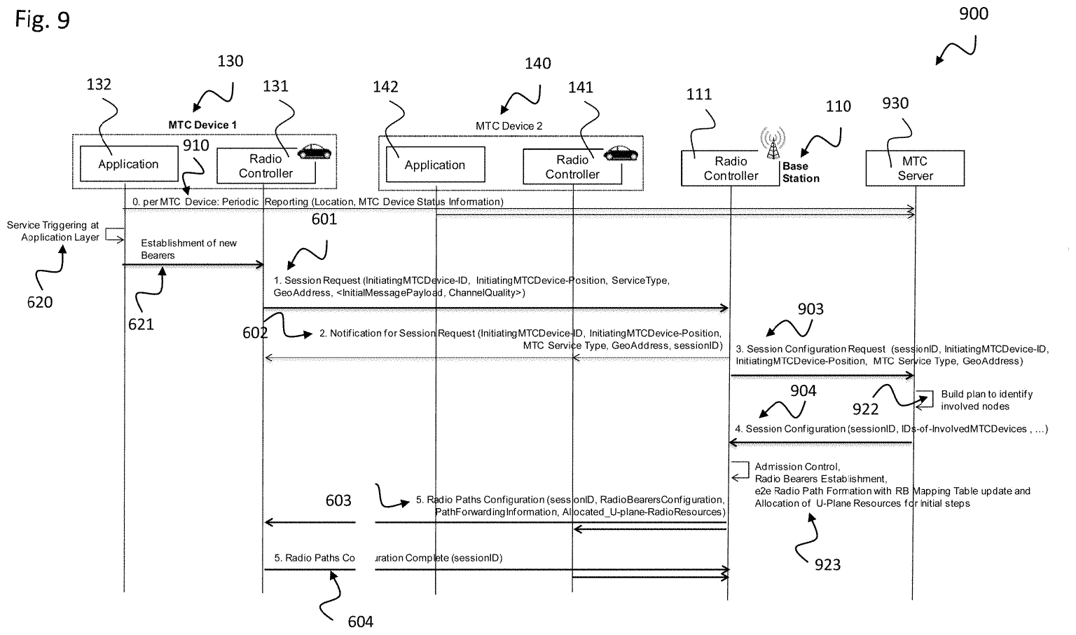

FIG. 9 shows a message sequence diagram of a communication system 900 illustrating signaling and interaction between the MTC devices and the base stations with an MTC server according to an implementation form. The message sequence diagram shown in FIG. 9 describes an exemplary scenario of Fast Radio Bearers' Establishment and Path Formation with the support of an MTC Server. As described above with respect to FIG. 6, after Service Triggering 620 at application layer 132 of an MTC device, for example the MTC device 1, 130 shown in FIG. 9, a message for “Establishment of new Bearers” 621 is sent to the radio controller 131 of the MTC device 130 to initiate the following procedure.

The BS 110 (i.e. its Radio Controller 111) can interact with another entity that keeps location and application-layer service information (named herein, as MTC Server 930) that can be used for the calculation/planning of the required resources and in general for the formation of the Radio Paths. For instance, the MTC Server 930 can be used either for the identification of involved MTC devices (e.g. MTC devices 1 and 2 in this example) in a specific service (e.g., when there is no knowledge of the IDs of involved devices, or when a GeoAddress is used) or for the retrieval of other application-layer information of the requested service (e.g., Service duration in a V2X lane merging service). This applies both to the case that the devices are located in a single cell and in multiple cells.

For the collection of the location and application-layer service information at the MTC Server 930, there is a Periodic Reporting 910 of location or status information from the MTC devices 130, 140 to the MTC Server 930 as shown in FIG. 9. For instance, in the case of a vehicle (MTC) device 130, 140 the status information may include, but is not limited to, the speed of the vehicle, the short term route of the vehicle, or sensor information.

The BS 110 requests information from the MTC Server 930 using the Session Configuration Request message 903. This message 903 includes the “sessionID”, the “InitiatingMTCDevice-ID”, the “InitiatingMTCDevice-Position”, the trigerred “MTC Service Type”, and the <ConfigurationType-ID, ConfigurationInfo>field. The latter includes a unique identifier that describes the type of the request (“ConfigurationType-ID”) together with some additional fields that are useful for the MTC Server 930 (“ConfigurationInfo”), according to the type of the request. In the case that the scope of the Session Configuration Request message 903 is to identify the list of the IDs of involved MTC devices 130, 140, based on the GeoNetworking Address (as described above with respect to FIG. 8), then the ConfigurationInfo includes the “GeoAddress”.

The Session Configuration message 904 provides the response from the MTC Server 930 to the BS 110, according to the Session Configuration Request message 903. This message 904 includes the “sessionID”, the “ConfigurationType-ID”, the list of Involved MTC devices (IDs-ofInvolvedMTCDevices) or any other application layer information (“ ”MTC Service Description”) that is necessary for the Radio Bearers establishment and Radio Path formation (e.g., expected duration of a V2X service).

As an additional option, because of the existence of the MTC Server 930 and the periodic reporting 910 from the MTC Devices 130, 140, the description of the IDs of Involved Devices (IDs-ofInvolvedMTCDevices) or the Geo-networking description (GeoAddress) in the Session Request message 601 can be omitted. In this case, the MTC Server 930 can provide this information through the Session Configuration response.

As an additional embodiment, the MTC Server 930 can directly send a Session Configuration message 904 or an Inter-node Session Request 703 (as described above with respect to FIG. 7) or message to another (neighboring) BS 120 in the case that multiple cells are involved in a specific MTC Service, e.g. as described above with respect to FIG. 7.

The communication messages between base station 110 and MTC devices 130, 140 may correspond to the messages described above with respect to FIG. 6, i.e. Session Request message 601, Notification for Session Request message 602, Radio Paths Configuration message 603 and Radio Paths Configuration Complete message 604.

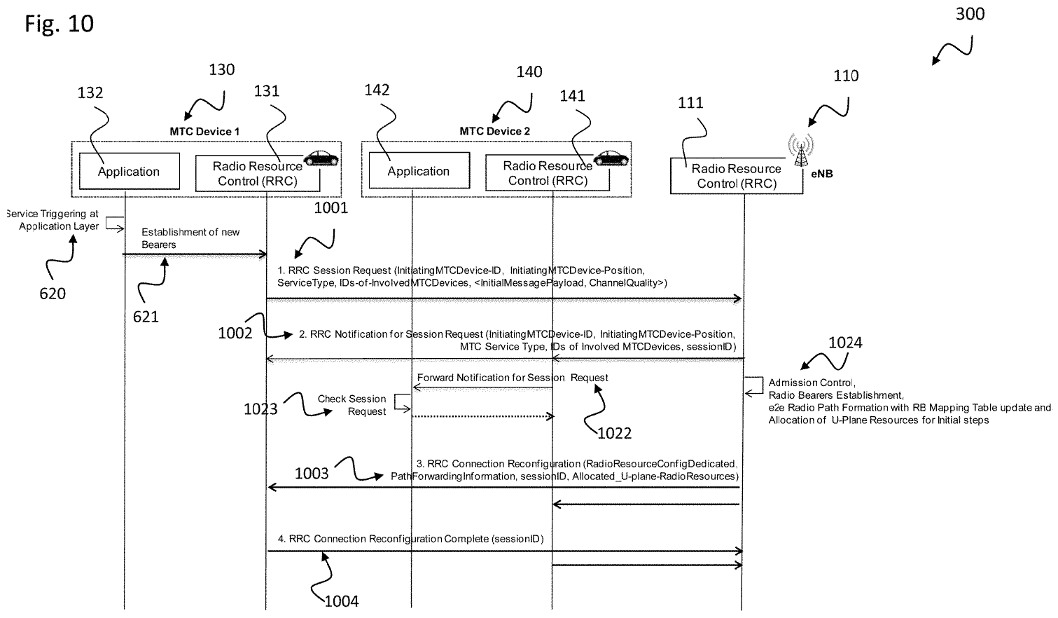

FIG. 10 shows a message sequence diagram of a communication system 1000 illustrating fast radio bearer establishment and radio path formation for an MTC service in an LTE network according to an implementation form. The message sequence diagram shown in FIG. 10 describes an exemplary implementation scenario in an LTE (Long Term Evolution) Network. In this LTE scenario, the RRC (Radio Resource Control) layers 111, 131, 141 correspond to the respective radio controllers 111, 131, 141 described above with respect to FIGS. 6-9. As described above with respect to FIG. 6, after Service Triggering 620 at application layer 132 of an MTC device, for example the MTC device 1, 130 shown in FIG. 10, a message for “Establishment of new Bearers” 621 is sent to the radio controller 131 of the MTC device 130 to initiate the following procedure.

When an MTC Service is triggered 620 the initiating MTC device 130 sends an “RRC Session Request” 1001 to the BS 110 (in FIG. 10 specified as eNB) in order to establish the radio bearers, the data paths and to provide the resources based on the QoS requirements of the specific service (e.g., V2X Cooperative Collision Avoidance). The content of this message 1001 is the same with the “Session Request” 601 described above with respect to FIG. 6. With the reception of the “RRC Session Request” 1001 the eNB 110 sends an “RRC Notification for Session Request” 1002 in order to notify the MTC devices in the same area (e.g. MTC devices 1 and 2 in this example) about the already transmitted “RRC Session Request” 1001 and thus to avoid multiple requests for the same event. The content of this message 1002 also corresponds to the content of the Notification for Session Request message 602 described above with respect to FIG. 6. The RRC (Radio Resource Control) layer 141 of MTC device 2, 140 (corresponding to the radio controller 141 as described above with respect to FIGS. 6 to 9) forwards 1022 notification for session request to the application layer 142 of MTC device 2. Then the application layer 142 checks the session request 1023 and answers the RRC 141 with Ack or Nack. Then, the “RRC Connection Reconfiguration” 1003 is transmitted to each involved MTC device 130, 140 as a response to the above procedures and includes the RadioResourceConfigDedicated information with the (updated) configuration of the different layers (MAC, RLC, PDCP . . . ) for the Uu interface extended with the Session ID and the allocated u-plane Radio Resources. The involved MTC devices 130, 140 confirm the successful completion of the establishment of the new Radio Bearers and the formation of the Radio Path for the specific service, with the transmission of the “RRC Connection Reconfiguration Complete” message 1004 to the eNB 110, which includes also the Session ID.

FIG. 11 shows a schematic diagram of a communication system 1100 including a base station 110 according to an implementation form and a group of communication devices 130, 140, 150, e.g. MTC devices according to an implementation form.

The base station BS is one example of a base station described above with respect to FIGS. 1 to 10, for example base station 110 or base station 120. The BS 110 can be used for enabling radio bearers' establishment and radio path formation to support end-to-end transmission of localized data among a group of communication devices, e.g. one or more of communication devices 130, 140, 150 described above with respect to FIGS. 1 to 10, in particular machine-type communication (MTC) devices.

The BS 110 includes a radio controller, e.g. a radio controller 111 as described above with respect to FIGS. 1 to 10. The radio controller 111 is configured: to receive a session request message 1101 from a communication device of the group of communication devices 130, 140, 150, e.g. from communication device 150 as described above with respect to FIGS. 1 to 10. The session request message 1101 may correspond to one of the messages 601, 801, 1001 as described above with respect to FIGS. 6 to 10. The session request message 1101 comprises information about a specific service 1104, e.g. as described above with respect to FIGS. 1 to 10. The radio controller 111 is further configured to establish a plurality of radio bearers 1102, 1103 among the group of communication devices 130, 140, 150 and to form a plurality of radio paths over the plurality of radio bearers 1102, 1103 according to the information about the specific service 1104 to support end-to-end transmission of localized data between the communication devices of the group of communication devices 130, 140, 150, e.g. as described above with respect to FIGS. 1 to 10, in particular FIGS. 3 and 4.

The radio controller 111 may initiate a session 320, 420 for providing the specific service 1104 and may generate a session identifier 330 indicating the initiated session 320, 420 and/or the specific service 1104, e.g. as described above with respect to FIGS. 1 to 10, in particular FIGS. 3 and 4.

The session request message 1101 may include information elements providing the information about the specific service 1104. The information elements may include one or more of the following parameters: a type 334, 336, 338 of the specific service 1104, a location of the communication device 150 transmitting the session request message 1101, information about communication devices 130, 140, 150 involved in the specific service 1104, application layer information, channel quality information of the communication device 150 transmitting the session request message 1101, in particular a reference signal receive power (RSRP) and/or a channel quality identifier (CQI), e.g. as described above with respect to FIGS. 1 to 10, in particular FIGS. 3 and 4.

The radio controller 111 may transmit a notification message 522 to the communication devices of the group of communication devices 130, 140, 150, e.g. as described above with respect to FIGS. 1 to 10, in particular FIG. 5. The notification message 522 includes information about the radio paths formation initiated by the session request message 521. The information about the radio paths formation may include one or more of the following parameters: an identifier of the communication device 130 initiating the session request message 521, a location of the communication device 130 initiating the session request message 521, a type of the specific service 1104, identifiers of the communication devices 130, 140, 150 involved in the specific service 1104, a session identifier of the specific service 1104, e.g. as described above with respect to FIGS. 1 to 10, in particular FIG. 5.

The BS 110 may include a radio bearers mapping table 512, configured to maintain information about the plurality of established radio bearers 1102, 1103, e.g. as described above with respect to FIGS. 1 to 10, in particular FIG. 5. The radio controller 111 may update and configure the radio bearers mapping table 512 based on the established radio bearers 1102, 1103. The radio controller 111 may generate a unique identifier in the radio bearers mapping table 512 for a specific session initiated by a session request message 521 and may associate all radio bearers 1102, 1103 established to support a specific transmission mode with the unique identifier, in particular a unicast transmission mode or a multicast transmission mode, e.g. as described above with respect to FIGS. 1 to 10, in particular FIGS. 3 and 4.

The radio controller 111 may transmit a radio paths configuration message 525 to the communication devices of the group of communication devices 130, 140, 150, e.g. as described above with respect to FIGS. 1 to 10, in particular FIG. 5. The radio paths configuration message 525 may include information about a configuration of the formed plurality of radio paths 1102, 1103. The information about the configuration of the formed plurality of radio paths 1102, 1103 may include one or more of the following data: a session identifier 330 that uniquely identifies the specific service 1104 and session, configuration information for the established plurality of radio bearers 1102, 1103, information for configuration of radio interface layers, information and identifiers from the radio bearers mapping table 512, control plane resources for transmission of a radio path configuration complete message 604, allocated user plane resources for initial data plane transmission, e.g. as described above with respect to FIGS. 1 to 10.

The radio controller 111 may receive a radio path configuration complete message 604 from each communication device 130, 140, 150 of the group of communication devices 130, 140, 150, e.g. as described above with respect to FIGS. 6 to 10. The radio path configuration complete message 604 indicates a successful completion of an establishment of radio bearers 1102, 1103 and formation of radio paths associated with the respective communication device 130, 140, 150. The radio path configuration complete message 604 may include one or more of the following data: a session identifier that identifies the specific service 1104 and session, an identifier of the communication device 150 transmitting the radio path configuration complete message 604 and a field indicating the outcome, e.g. success or fail.

The radio controller 111 may receive a second session request message from a second communication device 140 that requires participating in the specific service 1104. The radio controller 111 may transmit a session merge request message to the second communication device 140 allowing the second communication device 140 participating to an initiated session for providing the specific service 1104, e.g. as described above with respect to FIGS. 6 to 10.

The radio controller 111 may transmit an inter node session request message 703, e.g. as described above with respect to FIG. 7, to a neighboring base station 120 when the communication device 150 is attached to the neighboring base station 120. The inter node session request message 703 may include information about the specific service 1104 from the communication device 150, e.g. as described above with respect to FIG. 7.

The session request message 1101 may include a GeoNetworking Address, e.g. as described above with respect to FIG. 8, wherein the GeoNetworking Address indicates a geographical service area 1115 in which the specific service 1104 is provided by the BS 110.

FIG. 12 shows a schematic diagram of a communication system 1200 including a communication device 150, e.g. an MTC device according to an implementation form communicating with a BS 110 according to an implementation form.

The base station BS is one example of a base station described above with respect to FIGS. 1 to 11, for example base station 110 or base station 120. The BS 110 can be used for enabling radio bearers' establishment and radio path formation to support end-to-end transmission of localized data among a group of communication devices, e.g. one or more of communication devices 130, 140, 150 described above with respect to FIGS. 1 to 10, in particular machine-type communication (MTC) devices. The communication device can by any of the communication devices 130, 140, 150 described above with respect to FIGS. 1 to 11, e.g. communication device 150.

The communication device 150 includes a radio controller, e.g. a radio controller 151 as described above with respect to FIGS. 1 to 11. The radio controller 151 is configured: to transmit a session request message 1101 to a base station 110, in particular the BS 110 described above with respect to FIGS. 1 to 11. The session request message 1101 includes information about a specific service 1104. The session request message 1101 may correspond to one of the messages 601, 801, 1001 as described above with respect to FIGS. 6 to 10. The radio controller 151 is further configured to receive a radio paths configuration message 1153 from the BS 110. The radio paths configuration message 1153 includes information about a configuration of a radio path 1102. The radio paths configuration message 1153 may correspond to one of the messages 603, 1003 as described above with respect to FIGS. 6 to 10. The radio controller 151 is further configured to form and configure the radio path 1102 according to the information comprised in the radio paths configuration message 1153, e.g. as described above with respect to FIGS. 1 to 11.

The session request message 1101 may include information elements providing the information about the specific service 1104. These information elements may include one or more of the following data: a type of the specific service 1104, a location of the communication device 150, information about other communication devices 130, 140 involved in the specific service 1104, application layer information, channel quality information of the communication device 150, in particular a reference signal receive power (RSRP) and/or a channel quality identifier (CQI).

The radio controller 151 may receive a notification message from the BS 110. The notification message includes information about a specific service initiated by a session request message of another communication device 130, 140. The notification message may correspond to one of the messages 602, 802, 1002 as described above with respect to FIGS. 6 to 10.

The radio controller 151 may be configured to transmit the session request message 1101 to the base station 110 only if the information about the specific service 1104 comprised in the session request message 1101 differs from the information about the specific service comprised in the notification message, e.g. as described above with respect to FIGS. 6 to 10.

The radio controller 151 may be configured to transmit the session request message 1101 to the base station 110 if the type of the specific service 1104 is the same for both the notification message and the session request message 1101, but a number of communication devices 130, 140, 150 involved in the specific service is different for the notification message and the session request message 1101, e.g. as described above with respect to FIGS. 6 to 10.

The information about the configuration of the radio path 1102 may include one or more of the following data: a session identifier that uniquely identifies a session for providing the specific service 1104, configuration information for an established plurality of radio bearers 1102, 1103, information for configuration of radio interface layers of the communication device 150, information and identifiers from a radio bearers mapping table of the BS 110, control plane resources for transmission of a radio path configuration complete message, allocated user plane resources for initial data plane transmission.

The radio controller 151 may be configured to establish a communication with another communication device 130, 140 based on a local end-to-end radio data path between the communication device 150 and the other communication device 130, 140, e.g. as described above with respect to FIG. 7.

The communication device 150 may be associated by the specific service with a group of communication devices 130, 140, 150 located within a geographical service area 1115 in which the specific service is provided, e.g. as described above with respect to FIGS. 8 and 11.

The techniques described above provide fast establishment of radio bearers supporting fast exchange of localized data traffic. The disclosed devices and network entities may be based on a unique signaling in the radio interface, which involves exchange of new messages; messages that are already available are enhanced with new content as well. Additionally the interactions among the different network entities (user equipment, BSs) involve unique messages exchanges and introduction of new network functions. All the messages and entities are relevant to standardization.

The present disclosure also supports a method for enabling radio bearers' establishment and radio path formation to support end-to-end transmission of localized data among a group of communication devices, in particular machine-type communication (MTC) devices, the method comprising: receiving, by a radio controller, a session request message from a communication device of the group of communication devices, wherein the session request message comprises information about a specific service; and establishing, by the radio controller, a plurality of radio bearers among the group of communication devices and forming, by the radio controller, a plurality of radio paths over the plurality of radio bearers according to the information about the specific service to support end-to-end transmission of localized data between the communication devices of the group of communication devices, e.g. as described above with respect to FIGS. 1 to 12.

The present disclosure also supports a method for radio paths establishment and formation, the method comprising: transmitting, by a radio controller of a communication device, in particular a machine-type communication (MTC) device, a session request message to a base station, wherein the session request message comprises information about a specific service; receiving, by the MTC device, a radio paths configuration message from the BS, wherein the radio paths configuration message comprises information about a configuration of a radio path; and forming and configuring, by the MTC device, the radio path according to the information comprised in the radio paths configuration message, e.g. as described above with respect to FIGS. 1 to 12.

The present disclosure also supports a computer program product including computer executable code or computer executable instructions that, when executed, causes at least one computer to execute the performing and computing steps described herein, in particular the steps of the method described above. Such a computer program product may include a readable non-transitory storage medium storing program code thereon for use by a computer. The program code may perform the processing and computing steps described herein, in particular the method described above.

The techniques described in this disclosure are standard relevant. Various messages and information elements may require changes in the signaling. Besides, these messages may be transferred over Uu and/or Un interfaces.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the embodiments of the invention beyond those described herein. While the present embodiments of the invention have been described with reference to one or more particular embodiments, those skilled in the art recognize that many changes may be made thereto without departing from the scope of the present embodiments of the invention. It is therefore to be understood that within the scope of the appended claims and their equivalents, the embodiments of the invention may be practiced otherwise than as specifically described herein.

What is claimed is:

1. A base station (BS) for enabling establishment of radio bearers and radio path formation to support end-to-end transmission of localized data among a group of communication devices comprising machine-type communication (MTC) devices, the BS comprising:
a radio controller, configured to:
receive a session request message from a communication device of the group of communication devices, wherein the session request message comprises information about a specific service, and the information about the specific service comprises information about another communication devices involved in the specific service;
establish a plurality of radio bearers among the group of communication devices and to form a plurality of radio paths over the plurality of radio bearers according to the information about the specific service to support end-to-end transmission of localized data between the communication devices of the group of communication devices.

2. The BS of claim 1, wherein the radio controller is configured to initiate a session for providing the specific service and to generate a session identifier indicating the initiated session and/or the specific service.

3. The BS of claim 1, wherein the session request message comprises information elements providing the information about the specific service, the information elements comprise at least one of the following (a)-(d):
(a) a type of the specific service,
(b) a location of the communication device transmitting the session request message,
(c) application layer information comprising payload of transmitted message, and
(d) channel quality information of the communication device transmitting the session request message comprising a reference signal receive power (RSRP) and/or a channel quality identifier (CQI).

4. The BS of claim 1, wherein the radio controller is configured to transmit a notification message to the communication devices of the group of communication devices, wherein the notification message comprises information about the radio paths formation initiated by the session request message.

5. The BS of claim 4, wherein the information about the radio paths formation comprises at least one of the following (a)-(e):
(a) an identifier of the communication device initiating the session request message,
(b) a location of the communication device initiating the session request message,
(c) a type of the specific service,
(d) identifiers of the communication devices involved in the specific service, and
(e) a session identifier of the specific service.

6. The BS of claim 1, comprising:
a radio bearers mapping table, configured to maintain information about the plurality of established radio bearers,
wherein the radio controller is configured to update and configure the radio bearers mapping table based on the established radio bearers.

7. The BS of claim 1, wherein the radio controller is configured to receive a radio path configuration complete message from each communication device of the group of communication devices, wherein the radio path configuration complete message indicates a successful completion of an establishment of radio bearers and formation of radio paths associated with the respective communication device.

8. The BS of claim 7, wherein the radio path configuration complete message comprises at least one of the following (a)-(c):
(a) a session identifier that identifies the specific service and session,
(b) an identifier of the communication device transmitting the radio path configuration complete message, and
(c) a field indicating an outcome comprising a success or a fail.

9. The BS of claim 1, wherein the radio controller is configured to:
receive a second session request message from a second communication device that requires participating in the specific service;
transmit a session merge request message to the second communication device allowing the second communication device participating to an initiated session for providing the specific service.

10. The BS of claim 1, wherein the radio controller is configured to:
transmit an inter node session request message to a neighboring base station when the communication device is attached to the neighboring base station, wherein the inter node session request message comprises the information about the specific service from the communication device;
receive an inter node session response message from the neighboring base station in response to the inter node session request message; and
transmit an inter node session confirmation message to the neighboring base station in response to receiving the inter node session response message.

11. The BS of claim 1, wherein the session request message comprises a GeoNetworking Address, wherein the GeoNetworking Address indicates a geographical service area in which the specific service is provided by the BS.

12. The BS of claim 1, wherein the radio controller is configured to interact with an MTC server before establishing the plurality of radio bearers, by transmitting a session configuration request message to the MTC server and receiving a session configuration message from the MTC server in response to the session configuration request message.

13. A communication device comprising:
a radio controller, configured to:
transmit a session request message to a base station (BS), wherein the session request message comprises information about a specific service, and the information about the specific service comprises information about another communication device involved in the specific service;
receive a radio paths configuration message from the BS, wherein the radio paths configuration message comprises information about a configuration of a radio path; and
form and configure the radio path according to the information comprised in the radio paths configuration message.

14. The communication device of claim 13, wherein the session request message comprises information elements providing the information about the specific service, the information elements comprising at least one of the following (a) and (d):
(a) a type of the specific service,
(b) a location of the communication device,
(c) application layer information comprising payload of transmitted message,
(d) channel quality information of the communication device comprising a reference signal receive power (RSRP) and/or a channel quality identifier (CQI).

15. The communication device of claim 13, wherein the radio controller is configured to receive a notification message from the BS, wherein the notification message comprises information about a specific service initiated by a session request message of another communication device.

16. The communication device of claim 15, wherein the radio controller is configured to transmit the session request message to the base station only when the information about the specific service comprised in the session request message differs from the information about the specific service comprised in the notification message.

17. The communication device of claim 16, wherein the radio controller is configured to transmit the session request message to the base station when the type of the specific service is the same for both the notification message and the session request message, but a number of communication devices involved in the specific service is different for the notification message and the session request message.

18. The communication device of claim 13, wherein the information about the configuration of the radio path comprises at least one of the following (a)-(f):
(a) a session identifier that uniquely identifies a session for providing the specific service,
(b) configuration information for an established plurality of radio bearers,
(c) information for configuration of radio interface layers of the communication device,
(d) information and identifiers from a radio bearers mapping table of the BS,
(e) control plane resources for transmission of a radio path configuration complete message, and
(f) allocated user plane resources for initial data plane transmission.

19. The communication device of claim 13, wherein the radio controller is configured to establish a communication with another communication device based on a local end-to-end radio data path between the communication device and the other communication device.

20. The communication device of claim 13, wherein the communication device is associated by the specific service with a group of communication devices located within a geographical service area in which the specific service is provided.
